(19) United States
(12) Patent Application Publication
(10) Pub. No.: US 2008/0110557 A1
(43) Pub. Date: May 15, 2008

(54) Methods and Compositions for Providing Preferential Adhesion and Release of Adjacent Surfaces

(75) Inventor: Frank Y. Xu, Round Rock, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 11/560,266

(22) Filed: Nov. 15, 2006

(51) Int. Cl. B32B 38/10; B32B 37/12; C09J 4/02

(52) U.S. Cl. 156/247; 106/287.25; 106/287.24

(57) ABSTRACT

The present invention provides a method and composition for providing preferential adhesion and release of adjacent surfaces, that features solidifying a composition to form a solidified layer having first and second opposed sides, with the first side facing a first surface and being adhered thereto with a first adhesive forces and the second side facing the second surface and being adhered thereto with a second adhesive force, with the first and second adhesive forces establishing a predetermined preferential adhesion ratio. Generally, the first surface is covalently bonded to the first side and adhesion between the second side and the second surface occurs through Van der Waal forces. It has been found that the use of a fluorine group for enhancing the release properties (as a priori fluorinated release layer or a fluorinated release agent) is no longer needed for such method and composition. In one embodiment, the composition can be formed from an isobornyl acrylate component; an aliphatic urethane acrylate component; a 1,6-hexanediol diacrylate component; and a 2-hydroxy-2-methyl-1-phenyl-propan-1-one component. The first surface can be formed by polymerizing a compound formed from a multi-functional component that contains functional groups facilitating the formation of covalent bonds with the above mentioned polymerizable composition during an imprinting process, a cross-linking agent component, a catalyst component, and a solvent component. The second surface is usually a patterned or smoothed portion of a quartz mold.

### FIELD OF THE INVENTION

The field of invention relates generally to nano-fabrication of structures. More particularly, the present invention is directed to a method for adhering differing materials together that is suitable for use in imprint lithographic processes and a composition thereof.

### BACKGROUND OF THE INVENTION

Nano-scale fabrication involves the fabrication of very small structures, e.g., having features on the order of 100 nanometers or less. A promising process for use in nano-scale fabrication is known as imprint lithography. Exemplary imprint lithography processes are described in detail in numerous publications, such as United States Patent Application Publication No. 20040065976 (U.S. patent application Ser. No. 10/264,960), entitled “Method and a Mold to Arrange Features on a Substrate to Replicate Features having Minimal Dimensional Variability,” filed Oct. 4, 2002; United States Patent Application Publication No. 20040065252 (U.S. patent application Ser. No. 10/264,926), entitled “Method of Forming a Layer on a Substrate to Facilitate Fabrication of Metrology Standards,” filed Oct. 4, 2002; and United States Patent Application Publication No. 20040046271 (U.S. patent application Ser. No. 10/235,314), entitled “Method and a Mold to Arrange Features on a Substrate to Replicate Features having Minimal Dimensions Variability,” filed Sep. 5, 2002. All of these applications were assigned to the assignee of the present Application, and are incorporated by reference herein.

Referring to FIG. 1, a basic concept underlying imprint lithography is forming a relief pattern on a substrate that may function as, inter alia, an etching mask so that a pattern may be formed into the substrate that corresponds to the relief pattern. For example, a system 10 that can be employed to form such a relief pattern can include a stage 11 upon which a substrate 12 is supported, and further can include a template 14 having a mold 16 with a patterning surface 18 thereon. Patterning surface 18 may be substantially smooth and/or planar, or may be patterned so that one or more recesses are formed therein. Template 14 can be coupled to an imprint head 20 to facilitate movement of template 14. A fluid dispense system 22 can be coupled within the system 10 such that it is selectively placed in fluid communication with substrate 12 in order to deposit polymerizable material 24 thereon. A source 26 of energy 28 is coupled to direct energy 28 along a path 30. Generally, imprint head 20 and stage 11 are configured to arrange mold 16 and substrate 12, respectively, to be in superimposition, and disposed in path 30. Imprint head 20, stage 11, or both vary a distance between mold 16 and substrate 12 to define a desired volume therebetween that is filled by polymerizable material 24.

Typically, polymerizable material 24 is disposed upon substrate 12 before the desired volume is defined between mold 16 and substrate 12. However, polymerizable material 24 may fill the volume after the desired volume has been obtained. After the desired volume is filled with polymerizable material 24, source 26 produces energy 28, which causes polymerizable material 24 to solidify and/or crosslink, thus forming polymeric material conforming to the shape of the substrate surface 25 and mold surface 18. Control of this process can be regulated by processor 32 (that is in data communication with stage 11, imprint head 20, fluid dispense system 22, and source 26) operating on a computer-readable program stored in memory 34.

One criteria associated with accurately forming the pattern in the polymerizable material is to reduce, if not prevent, adhesion to the mold of the polymeric material, while ensuring suitable adhesion to the substrate. This is referred to as preferential release and adhesion properties. By preferential release and adhesions, the pattern recorded in the polymeric material is not distorted during separation of the mold. In the prior art, attempts to improve the release characteristics have employed a release layer on the surface of the mold. The release layer is typically hydrophobic and/or has low surface energy. The release layer adheres to the mold. Providing the release layer improves release characteristics. By doing so, this minimizes (or eliminates) distortions in the pattern recorded into the polymeric material that are attributable to mold separation. This type of release layer is referred to in the present Application as an a priori release layer, i.e., a release layer that is solidified to the mold.

For instance, in Bender et al., “Multiple Imprinting in UV-based Nanoimprint Lithography: Related Material Issues,” Microeletronic Engineering 61-62 (2002), pp. 407-413, Bender et al. employ a mold having an a priori release layer in conjunction with a fluorine-treated UV curable material. A UV curable layer is applied to a substrate by spin-coating a 200 cPs DV curable fluid to form a DV curable layer. The UV curable layer is enriched with fluorine groups for enhancing the release properties (i.e., a fluorine release agent).

In some instances, a priori release layer can also be a characteristic of the materials making up the mold itself, such as when the mold is made of silicone and has been designed to release layers upon its use. Such release of the layers of the mold is disadvantageous for multiple release. First, such materials would be much softer than quartz, which is a typical material used for molds in nano-imprint lithography. Due to this softness, they would be easily distorted, which is not a good feature for molds used in nano-imprint lithography. Furthermore, materials such as silicone or other like organic polymers, will swell due to contact with the imprinting materials. Such swelling of the mold materials is likewise not conducive to the precision needed for nano-imprint lithography. And because of the above, the use of such materials substantially limits the useful life of the mold and will require constant monitoring and replacement of the mold, which will increase the downtime of the process.

A need exists, therefore, to improve the preferential release and adhesion properties of a mold employed in imprint lithography processes.

### SUMMARY OF THE INVENTION

The present invention provides a method and composition for providing preferential adhesion and release of adjacent surfaces, that features solidifying a composition to form a solidified layer having first and second opposed sides, with the first side facing a first surface and being adhered thereto with a first adhesive forces and the second side facing the second surface and being adhered thereto with a second adhesive force, with the first and second adhesive forces establishing a predetermined preferential adhesion ratio. Generally, the first surface is covalently bonded to the first side and adhesion between the second side and the second surface occurs through Van der Waal forces. It has been found that the use of a fluorine group for enhancing the release properties (as a priori fluorinated release layer or a fluorinated release agent) is no longer needed for such method and composition.

To that end, in one embodiment, the composition can be formed from an isobornyl acrylate component; an aliphatic urethane acrylate component; a 1,6-hexanediol diacrylate component; and a 2-hydroxy-2-methyl-1-phenyl-propan-1-one component. The first surface can be formed by polymerizing a compound formed from a multi-functional component that contains functional groups facilitating the formation of covalent bonds with the above mentioned polymerizable composition during an imprinting process, a cross-linking agent component, a catalyst component, and a solvent component. The second surface is usually a patterned or smoothed portion of a quartz mold. The and other embodiments are described below.

### BRIEF DESCRIPTION OF THE DRAWINGS

FIG. 1 is a simplified plan view of a lithographic system in accordance with the prior art;

FIG. 2 is a simplified elevation view of a template and imprinting material disposed on a substrate in accordance with the present invention;

FIG. 3 is a simplified elevation view of the template and substrate, shown in FIG. 2, with the imprinting material being shown as patterned and solidified upon the layer;

FIG. 4 is a cross-sectional view of the template being removed from imprinting material in accordance with a first embodiment of the present invention;

FIG. 5 is a cross-sectional view of the template being removed from contacting imprinting material in accordance with a second embodiment of the present invention; and

FIG. 6 is a plan view showing the chemical structure of a component of a composition that may be employed to form the primer layer shown in FIGS. 2, 3, and 5, in accordance with a third embodiment of the present invention.

### DETAILED DESCRIPTION OF THE INVENTION

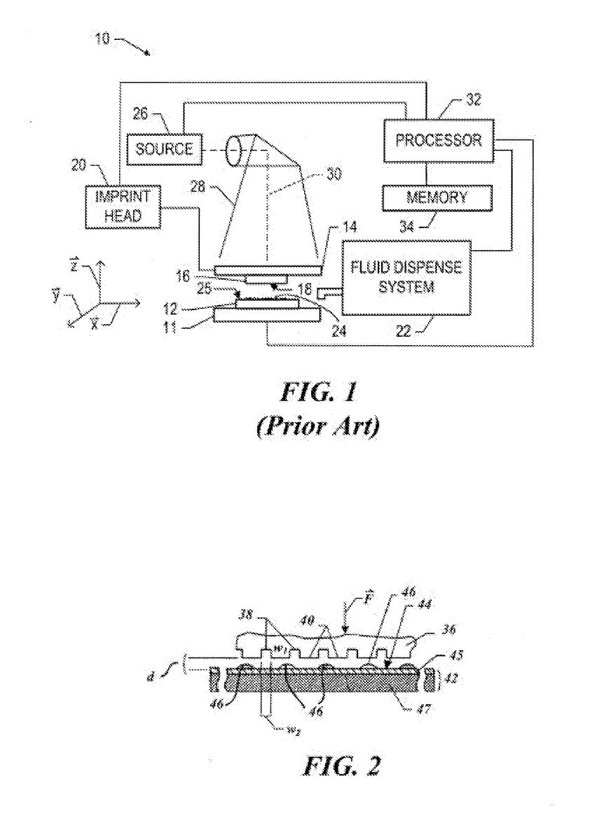

Referring to FIGS. 1 and 2, a mold 36, in accordance with the present invention, may be employed in system 10, and may define a surface having a substantially smooth or planar profile (not shown). Alternatively, mold 36 may include features defined by a plurality of spaced-apart recessions 38 and protrusions 40. The plurality of features defines an original pattern that forms the basis of a pattern to be formed on a substrate 42. Substrate 42 may comprise a bare wafer or a wafer with one or more layers disposed thereon, one of which is shown as primer layer 45. To that end, reduced is a distance “d” between mold 36 and substrate 42. In this manner, the features on mold 36 may be imprinted into a conformable region of substrate 42, such as an imprinting material disposed on a portion of surface 44 that presents a substantially planar profile. It should be understood that the imprinting material may be deposited using any known technique, e.g., spin-coating, dip coating and the like. As shown in FIG. 2, the imprinting material can be deposited as a plurality of spaced-apart discrete droplets 46 on substrate 42. Imprinting material is formed from a composition that may be selectively polymerized and cross-linked to record the original pattern therein, defining a recorded pattern.

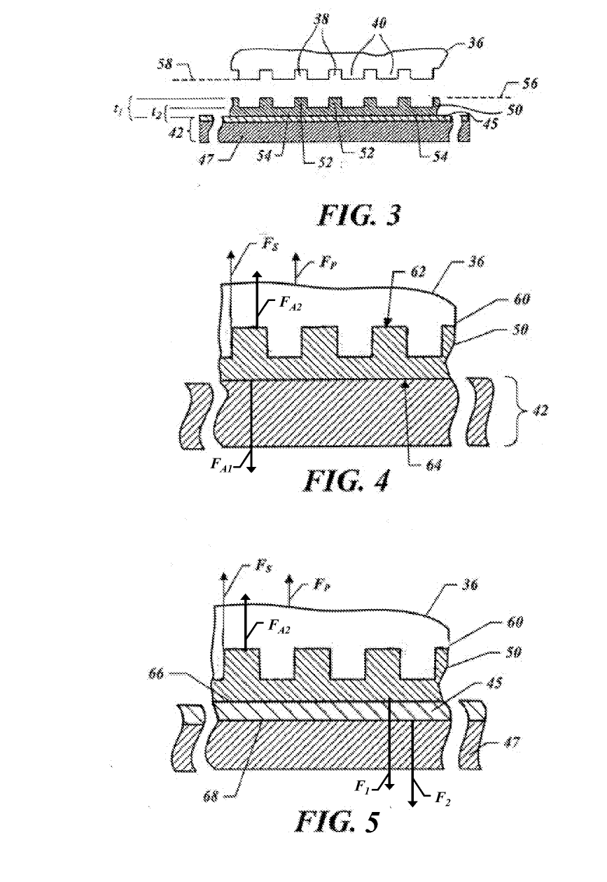

Specifically, the pattern recorded in the imprinting material can be produced, in part, by interaction with mold 36, e.g., electrical interaction, magnetic interaction, thermal interaction, mechanical interaction or the like. Referring to FIGS. 2 and 3, in the present example, mold 36 can come into mechanical contact with the imprinting material, spreading droplets 36, so as to generate a contiguous formation 50 of the imprinting material over surface 44. In one embodiment, distance “d” is reduced to allow sub-portions 52 of imprinting material to ingress into and fill recessions 38. To facilitate filling of recessions 38, before contact between mold 36 and droplets 46, the atmosphere between mold 36 and droplets 46 is saturated with helium or is completely evacuated or is a partially evacuated atmosphere of helium.

The imprinting material can be provided with the requisite properties to completely fill recessions 36 while covering surface 44 with a contiguous formation of the imprinting material. As shown in FIG. 3, in an embodiment of the invention, sub-portions 54 of imprinting material in superimposition with protrusions 40 remain after the desired, usually minimum, distance “d” has been reached. This action provides formation 50 with sub-portions 52 having a thickness t₁, and sub-portions 54, having a thickness t₂. Thicknesses “t₁” and “t₂” may be any thickness desired, dependent upon the application. Thereafter, formation 50 can be solidified by exposing the same to the appropriate curing agent, (e.g., actinic energy, such as broadband ultra violet energy, thermal energy or the like) depending upon the imprinting material. This can cause the imprinting material to polymerize and cross-link. The entire process may occur at ambient temperatures and pressures, or in an environmentally-controlled chamber with desired temperatures and pressures. In this manner, formation 50 is solidified to provide side 56 thereof with a shape conforming to a shape of a surface 58 of mold 36.

Referring to FIGS. 1, 2 and 3, the characteristics of the imprinting material are utilized to efficiently pattern substrate 42 in light of the novel patterning process employed. For example, the imprinting material can have certain characteristics to facilitate rapid and even filling of the features of mold 36 so that all thicknesses t₁ are substantially uniform and all thicknesses t₂ are substantially uniform. To that end, the viscosity of the imprinting material can be established, based upon the deposition process employed, to achieve the aforementioned characteristics. As mentioned above, the imprinting material may be deposited on substrate 42 employing various techniques. In embodiments wherein the imprinting material is deposited as a plurality of discrete and spaced-apart droplets 46, it can be desirable that a composition from which the imprinting material is formed have relatively low viscosity, e.g., in a range of 0.5 to 30 centipoises (cPs). Considering that the imprinting material can be spread and patterned concurrently, with the pattern being subsequently solidified into formation 50 by exposure to radiation, it is generally desired to have the composition wet surface of substrate 42 and/or mold 36 and to avoid subsequent pit or hole formation after polymerization. In embodiments wherein the imprinting material is deposited employing spin-coating techniques, it can be desired to use higher viscosity materials, e.g., having a viscosity greater than 10 cPs and typically, several hundred to several thousand cPs, with the viscosity measurement being determined in the absence of a solvent.

In addition to the aforementioned characteristics (referred to as liquid phase characteristics), generally, the composition provides the imprinting material with certain solidified phase characteristics. For example, after solidification of formation 50, the preferential adhesion and release characteristics are generally determined by the imprinting material. The composition from which the imprinting material is fabricated to provide formation 50 can provide preferential adhesion to substrate 42 and preferential release of mold 36. In this fashion, the probability of distortions in the recorded pattern that result from the separation of mold 36 is reduced. Furthermore, as distortions are due to, inter alia, tearing, stretching or other structural degradation of formation 50, the increase in the strength in formation 50 likewise generally reduces such distortion.

As for preferential adhesion, with reference to FIG. 4, for example, after deposition of the imprinting material upon separation of mold 36, formation 50 is subjected to a separation force F_{S}. Separation force F_{S} is attributable to a pulling force Fₚ on mold 36 and adhering forces F_{A2}, e.g., Van der Waals forces, between formation 50 and mold 36. Pulling force Fₚ is used to break the vacuum seal. It is desired that F_{A2} typically have a magnitude that is less than the magnitude of an adhering force F_{A1} between formation 50 and substrate 42. Should adhering force, F_{A2}, approach the magnitude of the adhering force F_{A1}, distortion and/or de-lamination of formation 50 from substrate 42 may occur. The ratio of adhering force F_{A1} to separation force F_{A2} (referred as the force ratio, F_{R}) can be at least about 2:1 and, more advantageously, at least about 5:1. In this manner, efficient decoupling of mold 36 from formation 50 may be performed without unduly distorting formation 50.

As for the strength of the formation 50, should the formation 50 not have sufficient tensile strength (including locally), the magnitude of F_{A2} may cause distortion even at high ratios of preferential adhesion. The application of F_{A2} will cause stress on the weak points of formation 50. Thus, for example, if the tensile strength of formation 50 is less than the force needed to decouple formation 50 from mold 36, than the application of F_{A2} will likely result in a tear of formation 50 instead of separating the formation 50 from mold 36. Moreover, if the tensile strength of formation 50 is not significantly high enough above F_{A2} such that locally formation 50 can withstand the application of F_{A2}, then tearing or other distortion can result. Thus, the tensile strength of formation 50 must be above the force need to separate formation 50 from mold 36 such that distortion does not occur during such separation.

The constituent components of the composition that form the imprinting material to provide each of the aforementioned characteristics may differ. This results from substrate 42 being formed from a number of different materials, i.e. providing differing magnitudes of adhering forces F_{A}As a result, the chemical composition of surface 44 varies dependent upon the material from which substrate 42 is formed. For example, substrate 42 may be formed from silicon, plastics, gallium arsenide, mercury telluride, and composites thereof. Substrate 42 may include one or more layers shown as primer layer 45, e.g., dielectric layer, metal layer, semiconductor layer, planarization layer and the like, upon which formation 50 is generated. Primer layer 45 would be deposited upon a wafer 47 employing any suitable technique, such as chemical vapor deposition, spin-coating and the like. Additionally, primer layer 45 may be formed from any suitable material, such as silicon, germanium and the like. Additionally, mold 36 may be formed from several materials, e.g., fused-silica, quartz, indium tin oxide diamond-like carbon, MoSi, sol-gels and the like.

A feature of the present invention is that with a sufficient force ratio (F_{R}) and with sufficient tensile strength of the composition as specified above, the composition need not include any fluorine groups that the art has generally added for enhancing the release properties.

In one embodiment, suitable imprinting materials from which to form formation 50 can comprise the following: (a) isobornyl acrylate; (b) aliphatic urethane acrylate; (c) 1,6-hexanediol diacrylate; and (d) 2-hydroxy-2-methyl-1-phenyl-propan-1-one.

In this embodiment, the acrylate component of the imprinting material, isobornyl acrylate (IBOA), has the following structure:

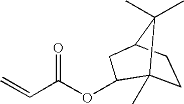

and can comprise approximately between about 20% and about 80% weight percent of the overall imprinting material. As a result, the mechanical properties of formation 50 are primarily attributable to the IBOA. An exemplary source for IBOA is Sartomer Company, Inc. of Exton, Pa., available under the product designation SR 506.

In this embodiment, the aliphatic urethane acrylate component can comprise between about 0% and about 50% weight percent of the overall imprinting material. The aliphatic urethane acrylate component is available from Rahn USA Corp., Aurora, Ill., under the designation Genomer 1122 and has the following structure:

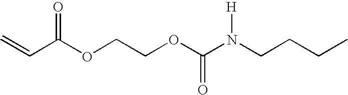

In this embodiment, the 1,6-hexanediol diacrylate component is available from UCB Chemicals, Smyna, Ga., under the designation HDODA and has the following structure:

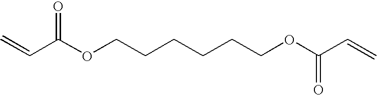

### The 1,6-hexanediol diacrylate component can comprise between about 10% and about 50% weight percent of the overall imprinting material.

Alternatively, other acrylate components (such as n-hexyl acrylate and ethelene glycol diacrylate) can be utilized.

In this embodiment, the initiator component, 2-hydroxy-2-methyl-1-phenyl-propan-1-one is available from Ciba Specialty Chemicals of Tarrytown, N.Y., under the trade name DAROCUR® 1173, and has the following structure:

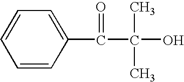

The initiator component can comprise about 3% weight percent of the overall imprinting material by weight, and generally may be present in a range of about 1% to 5% by percent weight of the overall imprinting material. The initiator is responsive to a broad band of ultra-violet radiation generated by a medium-pressure mercury lamp. In this manner, the initiator facilitates cross-linking and polymerization of the components of the imprinting material. The components of the imprinting material provide the same with a viscosity of approximately 11 cPs, which makes the same suitable for both drop-dispense and spin-coating techniques.

Referring to FIG. 5, in the presence of primer layer 45, a more complex situation exists due to the presence of two interfaces 66 and 68. At a first interface 66, a first adhering force F₁ is present between primer layer 45 and formation 50. At a second interface 68, a second adhering force, F₂, is present between primer layer 45 and wafer 47. It is desired that the mold adhesion force F_{A2} have a magnitude that is less than either adhering forces F₁ and F₂. (The lesser of F₁ and F₂ is F_{A1}, as this is the adherence force to which the formation 50 is adhered to substrate 42). Otherwise, de-lamination of formation 50 from primer layer 45, or de-lamination of primer layer 45 from wafer 47 or both may occur.

The present invention reduces, if not avoids, the de-lamination problem mentioned above by forming formation 50 and primer layer 45 from compatible materials that increases the probability that first F₁ and second F₂ adhering forces of the first and second interface, respectively, are greater than the mold adhesion force F_{A2}, while providing the desired force ratio, F_{R}, between F_{A1} and F_{A2}, such that F_{R} is at least about than 2:1 and, more advantageously, at least about 5:1. In the present embodiment, primer layer 45 is formed from a composition that forms strong bonds at interface 66, i.e., between primer layer 45 and formation 50, as well as, i.e., between interface 66, primer layer 45 and wafer 47. In the present example, adhesion between primer layer 45 and formation 50 at first interface 66 is the result of covalent bonding, i.e., covalent bonds between the composition from which primer layer 45 is formed and the composition from which formation 50 is formed are present. Adhesion between primer layer 45 and wafer 47 may be achieved through any one of various mechanisms. These mechanisms may include covalent bonds formed between the composition from which primer layer 45 is formed and the material from which wafer 47 is formed. Alternatively, or in addition to, the covalent bonds, ionic bonds may be formed between the composition from which primer layer 45 is formed and the material from which wafer 47 is formed. Alternatively, or in addition to, the covalent bonds, and/or the ionic bonds or both, adhesion between the composition from which primer layer 45 is formed and the material from which wafer 47 is formed may be achieved vis-a-vis Van der Waals forces.

This is achieved by forming primer layer 45 from a composition that includes a multi-functional reactive compound, i.e., a compound that contained two or more functional groups generally represented as follows:

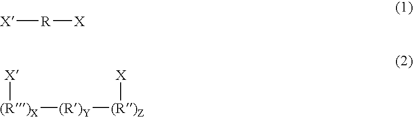

In which R, R′, R″ and R′″ are linking groups and x, y, z are averaged repeating numbers of the groups associated therewith. These repeating units can be randomly distributed. The groups X and X′ denote functional groups, and, typically, the functional group X differs from functional group X′. One of the functional groups X and X′, for example X′, is selected to achieve cross-reaction with the material from which substrate 42 is formed to adhere thereto by forming a covalent bond therewith, ionic bond therewith and/or Van der Waals forces.

One of the remaining functional groups X and X′, for example X, is selected to achieve cross-reaction with the material from which formation 50 is formed to form a covalent bond therebetween. The functionality of the X group is established so the cross-reaction occurs during polymerization of formation 50. As a result, the selection of functional group X depends upon the characteristics of the material from which formation 50 is formed. It is generally desired that functional group X reacts with the functional groups of the composition from which formation 50 is formed. For example, were formation 50 formed from acrylate monomers, X may be comprised of acrylic, vinyl ether, and or methacrylic functional groups, and/or functional groups that can copolymerize with acrylic groups in formation 50. As a result, X functional groups cross-react in response to ultraviolet actinic energy.

Functional groups X′ may also participate in the cross-linking and polymerization reactions of primer layer 45. Typically, X′ functional groups facilitate polymerization and cross-linking in response to an actinic energy that differs from the actinic energy in response to which X functional groups cross-react. The X′ functional groups in the present example facilitate cross-linking of molecules in primer layer 45 in response to exposure to thermal energy. Typically, functional groups X′ are selected to facilitate cross-reaction with substrate 42 through three mechanisms: 1) direct reaction with material from which substrate 42 is formed; 2) reaction with cross-linker molecules with a linking functional group of the cross-linker reacting with substrate 42; and 3) polymerization of and cross-linking of primer layer 45 so that chains of molecules of sufficient length may be developed to connected between formation 50 and substrate 42.

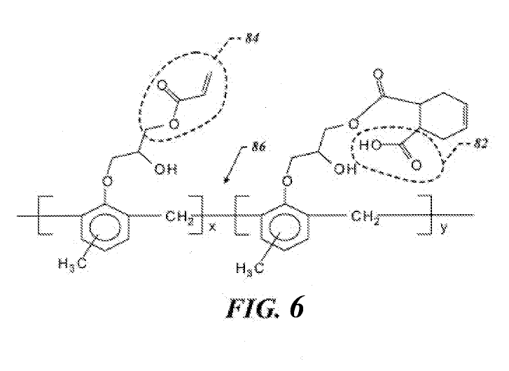

Referring to FIGS. 5 and 6, an embodiment of an exemplary multi-functional reactive compound that may be employed to form primer layer 45 in the presence of formation 50 being formed from a imprinting materials (such as specified above) can comprise the following: (a) a multi-functional component; (b) a cross-linking agent; (c) a catalyst; and (d) a solvent.

In this embodiment of the primer, the multi-functional component is an available from Schenectady International, Inc. in Schenectady, N.Y., under the product designation IsoRad 501 and can have either of the following structures:

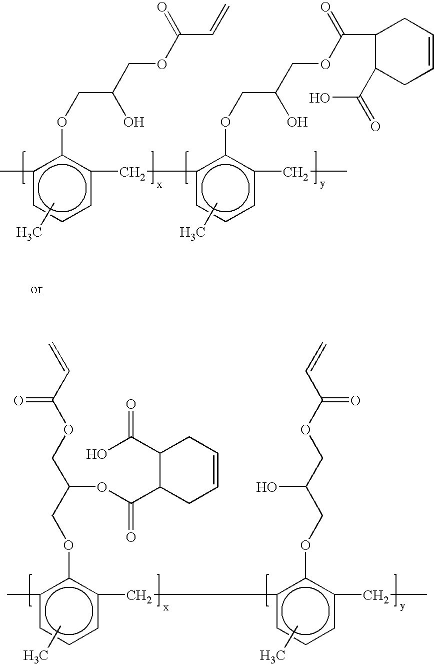

where x and y are integers indicating repeating units that are randomly distributed. The X′ functional group 82 provides carboxylic functionality. As shown in FIG. 6, the X functional group 84 provides acrylate functionality. Functional groups 82 and 84 are coupled to opposing ends of a backbone component 86. IsoRad® can comprises approximately 77%, weight percent of the primer composition (without solvent). The multi-functional component can be utilized in the primer in a range between about 20% and about 95% (weight percent).

In this embodiment of the primer, both the cross-linking agent and catalyst are available from Cytec Industries, Inc. of West Patterson, N.J. The cross-linking agent is sold under the product name Cymel 303ULF. One of the main components of Cymel 303ULF is hexamethoxymethyl-melamine (HMMM). The methoxyl functional groups of HMMM generally can participate in many condensation reactions. The primer can includes about 22 weight percent of Cymel 303ULF and about 1 weight percent of Cycat 4040 (without solvent). The cross-linking agent can be utilized in the primer in a range between about 5% and about 50% (weight percent) and the catalyst can be utilized in the primer in a range between about 0.1% and about 5% (weight percent). The multi-functional component, cross-linking agent, and the catalyst (such as IsoRad 501, Cymel 303ULF, and Cycat) are combined. The combination is then introduced into the solvent, such as approximately 1900 grams of PM Acetate. PM Acetate is a product name of a solvent consisting of 2-(1 Methoxy)propyl acetate sold by Eastman Chemical Company of Kingsport, Tenn. The ratio of the solvent to the combination of the multi-functional component, cross-linking agent, and the catalyst (without solvent) can be between about 1.5:1 and about 10,000:1. Typically, at lower ratios, solvent/combination mixtures will be thicker (i.e. have a higher viscosity) than at higher ratios of solvent/combination mixtures.

The following examples are provided to more fully illustrate some of the embodiments of the present invention. It should be appreciated by those of skill in the art that the techniques disclosed in the examples which follow represent techniques discovered by the inventor to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### EXAMPLE 1

In this Example 1, the following five compositions (A-E) were made:

| | |
|---|---|
| Components | part by weight |

Composition A

| | |
|---|---|
| isobornyl acrylate | 56 |
| aliphatic urethane acrylate | 21 |
| 1,6-hexanediol diacrylate | 20 |
| 2-hydroxy-2-methyl-1-phenyl-propan-1-one | 3 |

Composition B

| | |
|---|---|
| isobornyl acrylate | 56 |
| aliphatic urethane acrylate | 21 |
| 1,6-hexanediol diacrylate | 20 |
| 2-hydroxy-2-methyl-1-phenyl-propan-1-one | 3 |
| Zonyl FSO-100 | 0.5 |

Composition C

| | |
|---|---|
| isobornyl acrylate | 55 |
| aliphatic urethane acrylate | 21 |
| 1,6-hexanediol diacrylate | 20 |
| 1H,1H-perfluoro-n-decyl acrylate | 1 |
| 2-hydroxy-2-methyl-1-phenyl-propan-1-one | 3 |
| Zonyl FSO-100 | 0.5 |

Composition D

| | |
|---|---|
| isobornyl acrylate | 47 |
| n-hexyl acrylate | 25 |
| ethylene glycol diacrylate | 25 |
| 2-hydroxy-2-methyl-1-phenyl-propan-1-one | 3 |

Composition E

| | |
|---|---|
| isobornyl acrylate | 47 |
| n-hexyl acrylate | 25 |
| ethylene glycol diacrylate | 25 |
| 2-hydroxy-2-methyl-1-phenyl-propan-1-one | 3 |
| Masurf FS-2000 | 0.5 |

Compositions B, C, and E employ fluorinated surfactants, while Compositions A and D do not. Such fluorinated surfactants were added (as release agents) to these compositions to reduce the release force F_{A2}. Fluorinated surfactants that can be used to reduce such release force F_{A2} can include those from a group of nonionic fluorinated surfactant components having the following general formula:

F(CF₂CF₂)_{X}CH₂CH₂O(RO)_{Y}R′

where (RO)_{Y} is a poly(oxyalkylene) group, that includes groups having two to four carbon atoms such as —CH2CH2-, —CH2CH2CH2-, —CH(CH3)CH2-, or —CH(CH3)CH(CH3)-, and R′ is a terminal group of H or C1 to C4 alkyl, preferably H or methyl and X and Y are integers.

Other such examples of nonionic fluorinated surfactant components can have the following general formula:

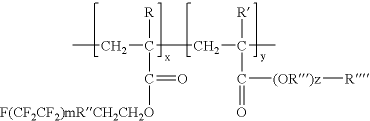

where R and R′ can be either H or methyl; R and R′ can be identical or differ. R″ is a linking group that may be omitted or a sulfonyl group such as —SO2N(R′″″)—, with R′″″ being C1 to C6 alkyl and typically C1 to C4 alkyl. The component (OR′″)_{Z} is a poly(oxyalkylene) group, typically including groups having 2 to 4 carbon atoms such as —CH2CH2-, —CH2CH2CH2-, —CH(CH3)CH2-, or —CH(CH3)CH(CH3)-R′″″ is a terminal group of methyl, H or C1 to C4 alkyl and typically H or methyl. The ratio of x to y is in a range of 1:2 to 3:1 and more preferably in a range of 1:1 to 2:1.

It should be understood that the oxyalkylene groups in the poly(oxyalkylene) group may be the same, as in poly(oxyethylene), or two or more of differing oxyalkylene units may be irregularly distributed in the poly(oxyalkylene) group. More specifically, the poly(oxyalkylene) group may be made up of straight or branched chain oxypropylene units alone or oxyethylene units alone, or straight or branched oxypropylene units and oxyethylene units may be present in alternate blocks. In the case of alternate blocks of oxyethylene and oxypropylene, the ratio the oxyethylene to oxypropylene is in a range of 2.0-0.5 to 1. Also, unattached blocks of poly(oxyalkylene) may be present in the polymer matrix. Chain transfer agents such as octyl mercaptan may be also present.

Suitable commercially available examples of non-ionic surfactant components included are sold by Dupont under product names ZONYL® FSO-100; sold by 3M Company under the product names FC-4432, FC-4430; sold by Mason Chemical Company of Arlington Heights, Ill. under the product names MASURF FS-2000; sold by Ciba-Geigy Corp under the product name Lodyne S-222N; and sold by Dainippon Ink & Chemical under the product name MegaFace R-08. As reflected above, Zonyl FSO-100 was utilized in Compositions B and C, and Masurf FS-2000 was utilized in Composition E.

While Applicants are unaware of any release agents that have been utilized in nano-imprint lithography that do not contain fluorine (i.e., non-fluorinated release agents), in concept, non-fluorinated release agents, such as siloxanes, are theoretical release agents that may be substitutable for fluorinated release agents. As reflected in the Examples 2-7 below, good results are obtainable without in the absence of any release agents (whether fluorinated or not).

### EXAMPLES 2-7

In Examples 2-7, the Compositions A-E were tested to determine imprinting performance under different conditions.

To determine the preferential release and adhesion characteristics, each of Compositions A-E was employed to form a imprinting material layer between two glass slides. Specifically, a formation was deposited upon primer layer 45 for a relevant composition (one of Compositions A-E) that both formation 50 and primer layer 45 were solidified between two glass slides (not shown). Each glass slide was approximately 1 mm thick, 75×25 mm in the lateral dimension.

Before deposition of imprinting material layer the glass slides were cleaned. Specifically each glass slide was exposed to Piranha solution (H₂SO₄: H₂O₂=2.5:1 by volume). The glass slides were subsequently rinsed with de-ionized water, sprayed with isopropyl alcohol, and exposed to a stream of fluid for drying, e.g., a stream of nitrogen gas. Thereafter, the glass slides were baked at 120° C. (Celsius) for 2 hours.

The imprinting material layer formed was deposited onto one or more of the two glass slides employing drop-dispense techniques. Specifically, a plurality of droplets of the material from which imprinting material layer is formed (i.e., the relevant Composition A-E) was dropped onto one or more of the two glass slides, which was subsequently sandwiched therebetween. Typically, a longitudinal axis of one of the two glass slides extended orthogonally to the longitudinal axis of the remaining glass slide. The imprinting material layer filled the space the glass slides then solidified, i.e., polymerized, and cross-linked by exposing the two glass slides to actinic energy, such as broad band ultraviolet wavelengths, using a medium pressure mercury UV lamp for 40 seconds at 20 mW/cm² intensity.

To measure the strength of the adhesion, a four-point bending fixture was adopted for the adhesion test, similar to that described in “Measurement of Adhesive Force Between Mold and Photocurable Resin in Imprint Technology” Japanese Journal of Applied Physics, Vol. 41 (2002) pp. 4194-4197. The maximum force/load was taken as the adhesion value. The beam distance of the top and bottom two points is 60 mm. The load was applied at the speed of 0.5 mm per minute.

As reflected by this process, none of these Examples 2-7 utilized a priori fluorinated treatment layer for enhancing release characteristics.

For Example 2, Composition A was utilized along with a primer that was made as described above utilizing 77 grams of IsoRad 501, 22 grams of Cymel 303ULF, 1 gram Cycat, and 1900 grams PM Acetate (the “IsoRad Primer”).

For Example 3, Composition A was utilized along with a primer known as DUV30J. DUV30J is a BARC materials made from Brewer Science, Rolla, Mo. Unlike the IsoRad Primer, DUV30J does not form covalent bonds with imprinting material. As shown below, the use of DUV30J was used as a layer 45 material in this and another example to compare its performance against that of the IsoRad Primer.

For Example 4, Composition B was utilized along with the IsoRad Primer.

For Example 5, Composition C was utilized along with the IsoRad Primer.

For Example 6, Composition D was utilized along with the IsoRad Primer.

For Example 7, Composition E was utilized along with DUV30J.

The imprinting results of Examples 2-7 are provided in Table 1 below.

TABLE 1

| | Ex. 2 | Ex. 3 | Ex. 4 | Ex. 5 | Ex. 6 | Ex. 7 |
|---|---|---|---|---|---|---|
| Composition | A | A | B | C | D | E |
| Tensile strength of | 30.0 | 30.0 | 30.0 | 30.0 | 24.7 | 24.7 |
| comp (MPa) | | | | | | |
| Priori fluorinated | No | No | No | No | No | No |
| release layer | | | | | | |
| Fluorinated release | No | No | Yes | Yes | No | Yes |
| agent added into | | | | | | |
| imprinting comp | | | | | | |
| Layer 45 material | IsoRad | DUV30J | IsoRad | IsoRad | IsoRad | DUV30J |
| | Primer | | Primer | Primer | Primer | |
| F_{A1} over a 25 × 25 mm | >20 | 4.0 | >20 | >20 | >20 | 4.0 |
| area (lb) | | | | | | |
| F_{A2} over a 25 × 25 mm | 2.4 | 2.4 | 0.8 | 0.8 | 3.2 | 0.9 |
| area (lb) | | | | | | |
| Adhesion ratio, F_{R} | >8 | 1.7 | >25 | >25 | >6 | 4.4 |
| (F_{A1}/F_{A2}) | | | | | | |
| Tensile Strength to | 1750 | 1750 | 5270 | 5270 | 1080 | 3850 |
| F_{A2} ratio | | | | | | |
| F_{R} * Tensile | >14,000 | 2,975 | >131,750 | >131,750 | >6,480 | 16,940 |
| Strength to F_{A2} ratio | | | | | | |
| Imprinting Result | No | Yes | No | No | Yes | No |
| (Distortion) | | | | | | |

In both Examples 2 and 3, Composition A was utilized, albeit with different primers (namely the IsoRad Primer and DUV30J, respectively). A comparison of Examples 2 and 3 reflects the benefits of increasing the adhesion ratio. In Example 3, the adhesion ratio was only 1.7, which resulted in distorted features, while Example 2 with its adhesion ratio greater than 8, did not. Such adhesion ratio should be at least about 2:1 and, more advantageously, at least about 5:1.

In Examples 2 and 6, Compositions A and D were utilized, respectively, along with the IsoRad Primer. A comparison of Examples 2 and 6 reveals that having a good adhesion ratio was not necessarily sufficient to achieve good imprinting results. In Example 6, while the adhesion ratio exceeded 5:1, the imprinted features were still distorted.

In Examples 2 and 6, Compositions A and D were utilized with the IsoRad Primer. In Example 7, Composition E was utilized with DUV30J. Composition D and E are the same compositions, except that 0.5 parts per weight of Masurf FS-2000 was added in Composition E. In a comparison between Examples 6 and 7, it is seen that in both cases the adhesion ratio was high. However, because the monomer to template adhesion force F_{A2} was significantly lower in Example 7, no distortion resulted in this example. A comparison of Example 2 and 6 shows the increase in tensile strength of the imprinting material can effect whether there is or is not distortion. The solidified material in Example 2 is stronger in tensile strength than the one in Example 6. In addition, there are benefits for having low enough absolute adhesion of solidified imprinting material to template to provide tolerable local stress on imprinted feature for the particular mechanical strength of the imprinting material involved. In Example 2, F_{A2} is significantly lower than the one in Example 6. Such comparisons reflect that the relationship between the tensile strength of the solidified composition and the monomer to template adhesion force F_{A2}.

In Examples 2, 4, and 5, Compositions A, B, and C were utilized along with the IsoRad Primer 5. In Examples 4 and 5, the compositions contained a fluorinated release agent. Example 2 show it is possible to achieve good imprinting results without priori fluorinated release layer and without adding any fluorinated release agent either. Without any release enhancement by fluorinated compound/layer, the F_{A2} (monomer to template adhesion) will increase naturally. Thus, an increase in the mechanical strength of the solidified imprinting material can be utilized in order to be able to tolerate the anticipated increased local stress on the imprinted features. Such ratio of the tensile strength of the imprinting material to F_{A2} (monomer to template adhesion) should be at least about 1,250:1 and, more advantageously, at least about 1,750:1. However, a comparison of Examples 2 and 3 reveals that having a good tensile strength to F_{A2} ratio was not necessarily sufficient to achieve good imprinting results. In Example 3, while this ratio was around 1750:1 (and the same as in Example 2), the imprinted features were still distorted.

These examples reflect that good imprinting results can be achieved through the combination of (a) a high adhesion ratio, (b) strong mechanical properties reflected in high tensile strength, and (c) low enough F_{A2} to provide tolerable local stress on imprinted feature for the particular mechanical strength of the imprinting material involved. Thus, Example 2 is an imprinting success, even in the absence any prior fluorinated release layer and without adding any fluorinated release agent. As such, the ratio of the (i) the product of the adhesion ratio and the tensile strength of the imprinting material to (ii) the monomer to template adhesion (F_{A2}) should be at least about 7,500:1, and, more advantageously, at least about 10,000:1, and even more advantageously, at least about 14,000:1.

The embodiments of the present invention described above are exemplary. Many changes and modifications may be made to the disclosure recited above while remaining within the scope of the invention. The scope of the invention should not, therefore, be limited by the above description, but instead should be determined with reference to the appended claims along with their full scope of equivalents.

What is claimed is:

1. An imprinting method comprising:
(a) placing a first surface and a second surface in superimposition and spaced-apart defining a volume therebetween, wherein the second surface does not have a priori release layer;
(b) occupying said volume with a flowable composition, wherein the composition does not comprise a fluorinated release agent;
(c) solidifying said composition to form a solidified layer having first and second opposed sides, wherein
(i) said first side is facing said first surface and being adhered thereto with a first adhesive force, and
(ii) said second side is facing said second surface and being adhered thereto with a second adhesive force; and
(d) separating the second side of the solidified layer from said second surface, while maintaining adhesion to the first side of the solidified layer to said first surface without distortion of the solidified layer.

2. The imprinting method as recited in claim 1, wherein the first adhesive force and the second adhesive force establish a first to second adhesion ratio and said first to second adhesion ratio is at least about 2:1.

3. The imprinting method as recited in claim 2 wherein said first to second adhesion ratio is at least about 5:1.

4. The imprinting method as recited in claim 1, wherein said occupying step further comprises providing said first side with a substantially smooth profile and providing said side surface with a features profile.

5. The imprinting method as recited in claim 1, wherein said solidified composition is covalently bonded to said first surface and wherein said second side and second surface are adhered by Van der Waal forces.

6. The imprinting method as recited in claim 1, wherein tensile strength of the solidified imprinting material is at least about 25 MPa.

7. The imprinting method as recited in claim 1, wherein tensile strength of the solidified imprinting material and the second adhesive force establish a tensile strength to second adhesion ratio and said tensile strength to second adhesion ratio is at least about 1250:1.

8. The imprinting method as recited in claim 1, wherein said composition comprises an isobornyl acrylate component and an acrylate component.

9. The imprinting method as recited in claim 8, wherein said acrylate component is an aliphatic urethane acrylate component and said composition further comprises a 1,6-hexanediol diacrylate component, and a 2-hydroxy-2-methyl-1-phenyl-propan-1-one component.

10. The imprinting method as recited in claim 9 further comprising forming said first surface by polymerizing a compound formed from a multi-functional component, a cross-linking agent component, a catalyst component and a solvent component.

11. The imprinting method as recited in claim 1 further comprising forming said first surface by polymerizing a compound formed from a multi-functional component, a cross-linking agent component, a catalyst component and a solvent component.

12. The imprinting method of claim 1, wherein the second surface does not have a release layer.

13. The imprinting method of claim 1, wherein the composition does not comprise a releasing agent.

14. An imprinting method comprising:
(a) forming a first surface by polymerizing a compound formed from a multi-functional component, a cross-linking agent component, a catalyst component and a solvent component;
(b) placing a quartz surface in superimposition with said first surface and spaced apart therefrom, defining a volume therebetween, wherein said quartz surface does not have a priori release layer;
(c) occupying said volume with composition including an isobornyl acrylate component, an aliphatic urethane acrylate component, a 1,6-hexanediol diacrylate component, and a 2-hydroxy-2-methyl-1-phenyl-propan-1-one component;
(d) solidifying said composition to form a solidified layer having first and second opposed sides, wherein
(i) said first side is facing said first surface and being adhered thereto with a first adhesive force,
(ii) said second side is facing said quartz surface and being adhered thereto with a second adhesive force, and
(iii) the first adhesive force is greater than the second adhesive force.

15. The imprinting method as recited in claim 14, wherein said composition does not comprise a fluorinated release agent.

16. The imprinting method as recited in claim 14 further comprising separating the second side of the solidified layer from said quartz surface, while maintaining adhesion to the first side of the solidified layer to said first surface without distortion of the solidified layer.

17. The imprinting method as recited in claim 14, further comprising, before said occupying step, providing said first side with a substantially smooth profile and providing said side surface with a features profile.

18. The imprinting method as recited in claim 14, wherein the first surface has a primer disposed thereon, wherein said primer is formed from
(a) a multi-functional component;
(b) a cross-linking agent;
(c) a catalyst; and
(d) a solvent.

19. The imprinting method as recited in claim 14 wherein tensile strength of the solidified imprinting material is at least about 25 MPa.

20. A composition for providing preferential adhesion and release of adjacent surfaces, said method comprising:
(a) isobornyl acrylate;
(b) aliphatic urethane acrylate;
(c) 1,6-hexanediol diacrylate; and
(d) 2-hydroxy-2-methyl-1-phenyl-propan-1-one.

21. The composition as recited in claim 20, wherein the composition does not comprise a fluorinated release agent.

22. The composition as recited in claim 20, wherein said composition comprises:
(a) the isobornyl acrylate in an amount between about 20% and 80% weight percent of the composition;
(b) the aliphatic urethane acrylate in amount between about 0% and about 50% weight percent of the composition;
(c) the 1,6-hexanediol diacrylate in an amount between about 10% and 50% weight percent of the composition; and
(d) said the 2-hydroxy-2-methyl-1-phenyl-propan-1-one in an amount between about 1% and 5% of the composition.

23. The composition as recited in claim 20 further comprising a surfactant, wherein the surfactant comprises at least about 0.5% of said composition.

24. The composition as recited in claim 20, further comprising a fluorinated release agent.

25. The composition as recited in claim 24, wherein the fluorinated release agent comprises 1H, 1H-perfluoro-n-decyl acrylate.

26. A composition comprising an imprinting material, wherein said imprinting materials does not include a fluorinated release agent, and further wherein, when said imprinting material is solidified between a first surface and a second surface that does not have a priori release layer:
(a) the solidified imprinting material has
(i) a first side adhered to the first surface at a first adhesive force,
(ii) a second side adhered to the second surface at a second adhesive force, wherein there is an adhesion ratio between the first adhesive force and the second adhesive force;
(b) the solidified imprinting material has a tensile strength; and
(c) the second adhesive force is sufficiently low and the adhesion ratio and the tensile strength are sufficiently high, such that their combination is operable to allow the second side of the solidified imprinting material to be separated from the second surface without distortion of the solidified imprinting material.

27. The composition as recited in claim 26, wherein (i) product of the adhesion ratio and the tensile strength of the solidified imprinting material and (ii) the second adhesive force establish an adhesion ratio-tensile strength to second adhesive force ratio and said adhesion ratio-tensile strength to second adhesive force ratio is at least about 7,500:1.

28. The composition as recited in claim 26, wherein
(a) the adhesion ratio is at least about 2:1;
(b) the tensile strength of the solidified imprinting material and the second adhesive force establish a tensile strength to second adhesion ratio and said tensile strength to second adhesion ratio is at least about 1250:1; and
(c) product of the adhesion ratio and the tensile strength to second adhesion ratio is at least about 7,500:1.

29. An imprinting method comprising:
(a) selecting a flowable imprinting material that when solidified has a tensile strength, wherein the imprinting material does not comprise a fluorinated release agent;
(b) occupying the imprinting material between a first surface and a second surface in superimposition and spaced-apart defining a volume therebetween, wherein the imprinting material occupies the volume and wherein the second surface does not have a priori release layer;
(c) solidifying said imprinting materials, wherein the solidified imprinting material has
(i) a first side adhered to the first surface at a first adhesive force,
(ii) a second side adhered to the second surface at a second adhesive force, wherein there is an adhesion ratio between the first adhesive force and the second adhesive force, and
(iii) a tensile strength, and
(d) applying a separation force at least about the second adhesive force so that that the second side of the imprinting material separates from the second surface, wherein the adhesion ratio and the tensile strength are at least at a level wherein the imprinting materials does not distort during said separation of the second side from the second surface.

30. The imprinting method as recited in claim 29, wherein the solidified imprinting material has a tensile strength of at least about 25 MPa and the adhesive ratio is at least about 2:1.

31. The imprinting method as recited in claim 30, wherein the adhesive ratio is at least about 5:1.

32. The imprinting method as recited in claim 29, wherein (i) product of the adhesion ratio and the tensile strength of the solidified imprinting material and (ii) the second adhesive force establish an adhesion ratio-tensile strength to second adhesive force ratio and said adhesion ratio-tensile strength to second adhesive force ratio is at least about 7,500:1.

33. The imprinting method as recited in claim 32, wherein said adhesion ratio-tensile strength to second adhesive force ratio is at least about 10,000.

34. The imprinting method as recited in claim 32, wherein said adhesion ratio-tensile strength to second adhesive force ratio is at least about 14,000.

35. The imprinting method as recited in claim 29, wherein
(a) the adhesion ratio is at least about 2:1;
(b) the tensile strength of the solidified imprinting material and the second adhesive force establish a tensile strength to second adhesion ratio and said tensile strength to second adhesion ratio is at least about 1250:1; and
(c) product of the adhesion ratio and the tensile strength to second adhesion ratio is at least about 7,500:1.

36. The imprinting method as recited in claim 35, wherein
(a) the adhesion ratio is at least about 5:1;
(b) said tensile strength to second adhesion ratio is at least about 1750:1; and
(c) the product of the adhesion ratio and the tensile strength to second adhesion ratio is at least about 14,000.
